(19) United States
(12) Patent Application Publication
(10) Pub. No.: US 2019/0036560 A1
(43) Pub. Date: Jan. 31, 2019

(54) Receiving circuit of wireless communication system and method of receiving radio frequency signal

(71) Applicant: REALTEK SEMICONDUCTOR CORPORATION, Hsinchu (TW)

(72) Inventor: YI-CHANG SHIH, Hsinchu City (TW)

(21) Appl. No.: 16/046,207

(22) Filed: Jul. 26, 2018

(30) Foreign Application Priority Data
Jul. 28, 2017 (TW) 106125418

(51) Int. Cl. H04B 1/16; H04B 1/00

(52) U.S. Cl. CPC H04B 1/16; H04B 1/0003

(57) ABSTRACT

A receiving circuit of a wireless communication system and a method of receiving a radio frequency (RF) signal are disclosed. The method of receiving an RF signal is applied to a receiving circuit of a wireless communication system. The method includes the steps of: generating a reference clock according to a base clock; generating a working clock according to the reference clock; generating a control signal according to signal energy of an interference signal before the RF signal is received; adjusting the reference clock and/or the working clock according to the control signal; down-converting the RF signal according to the reference clock to generate a down-converted signal; and converting the down-converted signal to a digital signal according to the working clock.

### BACKGROUND OF THE INVENTION

### 1. Field of the Invention

The present invention generally relates to wireless communication, and, more particularly, to a receiving circuit of a wireless communication system and a method of receiving radio frequency (RF) signals.

### 2. Description of Related Art

As many circuits in a receiving end of a wireless communication system need clock to function properly, a stable reference clock is required. Since the reference clock is not an ideal sine or sinusoidal wave the reference clock contains not only the fundamental frequency signal but several spur signals (spurs) whose frequencies are multiples of the fundamental frequency. In general, the frequency of a spur is an integral multiple of the fundamental frequency, and the higher the frequency, the lower power the spur has. As the receiving end of a wireless communication system pursues higher performance (such as higher signal sensitivity and higher signal-to-noise ratio (SNR)), a low-power spur may still be taken into consideration by the circuits in the receiving end, resulting in signal errors. A prior art method was proposed to use a notch filter to filter out the spurs; if, however, the frequency of the spur falls within the frequency band of the signal to be received, the notch filter can possibly filter out part of the target signal at the same time. A prior art signal canceling method was also proposed in which a signal whose phase is an inversion of the spur is generated to cancel out the spur. This method, however, may mistakenly cancel out part of the target signal due to failing to correctly distinguish the spur from the target signal.

### SUMMARY OF THE INVENTION

In view of the issues of the prior art, an object of the present invention is to provide a receiving circuit of a wireless communication system and a radio frequency (RF) signal receiving method to reduce signal interference and improve circuit performance, so as to make an improvement to the prior art.

A receiving circuit of a wireless communication system is provided. The receiving circuit receives an RF signal and includes a reference clock generation circuit, a radio frequency receiving circuit, a working clock generation circuit, an analog-to-digital converter, and a digital baseband circuit. The reference clock generation circuit generates a reference clock according to a base clock. The radio frequency receiving circuit receives the RF signal through an antenna and down-converts the RF signal according to the reference clock to generate a down-converted signal. The working clock generation circuit is coupled to the reference clock generation circuit and configured to generate a working clock according to the reference clock. The analog-to-digital converter is coupled to the radio frequency receiving circuit and the working clock generation circuit and configured to convert the down-converted signal to a digital signal according to the working clock. The digital baseband circuit is coupled to the working clock generation circuit, the analog-to-digital converter, and the reference clock generation circuit and configured to process the digital signal and generate a control signal according to multiple sets of parameter combinations before the radio frequency receiving circuit receives the RF signal. The control signal controls the reference clock generation circuit to adjust the reference clock and/or controls the working clock generation circuit to adjust the working clock.

A radio frequency signal receiving method applied to a receiving circuit of a wireless communication system for receiving an RF signal is provided. The method includes steps of: generating a control signal according to one of multiple sets of parameter combinations before the RF signal is received; adjusting a reference clock and/or a working clock according to the control signal; measuring signal energy; determining a target set of parameter combination from the sets of parameter combinations according to the signal energy; adjusting the reference clock and/or the working clock according to the target set of parameter combination; down-converting the RF signal according to the reference clock to generate a down-converted signal; and converting the down-converted signal to a digital signal according to the working clock. The reference clock is generated according to a base clock, and the working clock is generated according to the reference clock.

A radio frequency signal receiving method applied to a receiving circuit of a wireless communication system for receiving an RF signal is also provided. The method includes steps of: generating a reference clock according to a base clock; generating a working clock according to the reference clock; generating a control signal according to signal energy of an interference signal before the RF signal is received; adjusting the reference clock and/or the working clock according to the control signal; down-converting the RF signal according to the reference clock to generate a down-converted signal; and converting the down-converted signal to a digital signal according to the working clock.

In the present invention, the receiving circuit of the wireless communication system and the RF signal receiving method can adjust the parameters of the circuit before the RF signals are actually received. This approach can reduce as much as possible the influence of the interference signal that inherently exists in the circuit, thereby improving the circuit performance. Compared with the prior art, the present invention does not mistakenly filter out or cancel the target signal, and thus has higher reliability.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 illustrates a functional block diagram of a receiving circuit of a wireless communication system according to an embodiment of the present invention.

FIG. 2 illustrates a circuit diagram of the reference clock generation circuit 140 according to an embodiment of the present invention.

FIG. 3 illustrates a circuit diagram of the working clock generation circuit 150 according to an embodiment of the present invention.

FIG. 4 illustrates a flowchart of a radio frequency (RF) receiving method according an embodiment of the present invention.

### DETAILED DESCRIPTION OF THE EMBODIMENTS

The following description is written by referring to terms of this technical field. If any term is defined in this specification, such term should be explained accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a receiving circuit of a wireless communication system and a radio frequency (RF) signal receiving method that are capable of reducing signal interference to improve circuit performance. On account of that some or all elements of the receiving circuit could be known, the detail of such elements is omitted provided that such detail has little to do with the features of this disclosure and this omission nowhere dissatisfies the specification and enablement requirements. Some or all of the processes of the RF signal receiving method may be implemented by software and/or firmware, and can be performed by the receiving circuit of the wireless communication system or its equivalent. A person having ordinary skill in the art can choose components or steps equivalent to those described in this specification to carry out the present invention, which means that the scope of this invention is not limited to the embodiments in the specification.

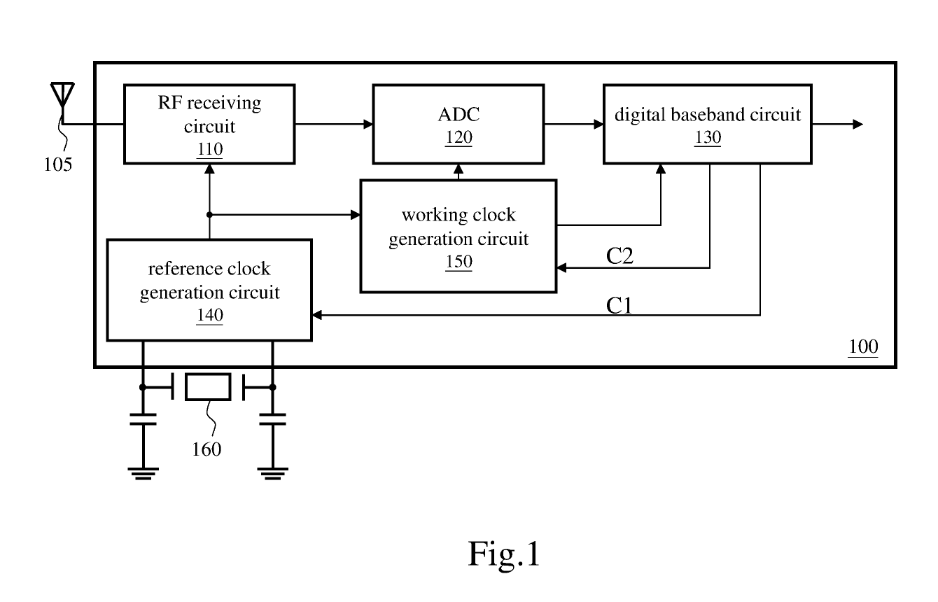

FIG. 1 is a functional block diagram of a receiving circuit of a wireless communication system according to an embodiment of the present invention. The receiving circuit of the wireless communication system includes an RF receiving circuit 110, an analog-to-digital converter (ADC) 120, a digital baseband circuit 130, a reference clock generation circuit 140, and a working clock generation circuit 150. The above elements, for example, can be implemented, through integrated circuits, in the communication chip 100. The reference clock generation circuit 140 generates a reference clock according to the base clock generated by the crystal oscillator 160. The crystal oscillator 160 is mounted on the circuit board on which the communications chip 100 is arranged. The reference clock generation circuit 140 is, for example, a starting of oscillation and control circuit for the quartz crystal. The RF receiving circuit 110 receives the RF signal through the antenna 105, amplifies the RF signal, and then down-converts the RF signal to generate a down-converted signal (e.g., an intermediate frequency or baseband signal). The RF receiving circuit 110 uses, for example, a mixer (not shown) to down-convert the RF signal according to the reference signal. The working clock generation circuit 150 generates a working clock (or a sampling clock) according to the reference clock. The working clock generation circuit 150 can be implemented using, for example, a frequency synthesizer or a phase-locked loop (PLL). The PLL can be an integer type or a fractional type. The ADC 120 converts the down-converted signal to a digital signal according to the working clock. The digital baseband circuit 130 then processes the digital signal (such as demodulation, decoding, etc.) to obtain the data carried by the RF signal.

The spur accompanying a non-ideal reference clock and/or working clock may be coupled into the RF receiving circuit 110 and/or ADC 120 via circuitry. This spur exists before the RF signals are received via the antenna 105. Before the RF receiving circuit 110 receives the RF signals, the digital baseband circuit 130 generates the control signals C1 and C2 based on multiple sets of parameter combinations. Each set of parameter combination includes, for example, a first parameter associated with the characteristics of the reference clock such as the phase, amplitude, and/or duty cycle, and/or a second parameter associated with the characteristics of the working clock such as the phase and/or amplitude. The control signals C1 and C2 respectively control the reference clock generation circuit 140 and the working clock generation circuit 150. The reference clock generation circuit 140 adjusts the reference clock in response to the control signal C1, and the working clock generation circuit 150 adjusts the working clock in response to the control signal C2. More specifically, the digital baseband circuit 130 may control, through the control signal C1, the reference clock generation circuit 140 to adjust parameters such as the phase, amplitude, and/or duty cycle of the reference clock. The digital baseband circuit 130 may control, through the control signal C2, the working clock generation circuit 150 to adjust parameters such as the phase and/or amplitude of the working clock. The digital baseband circuit 130 may adjust either both the reference clock generation circuit 140 and the working clock generation circuit 150 or only one of the two before the RF receiving circuit 110 receives the RF signal. In a case where the reference clock generation circuit 140 and the working clock generation circuit 150 are both controlled and adjusted, the control signal C1 and the control signal C2 may be the same control signal, or different signals.

Each time after the control reference clock generation circuit 140 and/or working clock generation circuit 150 adjust(s) parameters, the digital baseband circuit 130 measures the signal energy (e.g., the amplitude or signal power of the voltage or current signal) of the interference signal in the digital domain, and associates the measured signal energy with the set of parameter combination that is currently employed to generate the control signal. Next, the baseband circuit 130 determines whether all sets of parameter combinations have been processed. If not all sets of parameter combinations have been processed (i.e., if not each set of parameter combination has been used to generate the corresponding control signal(s) C1 and/or C2), then the digital baseband circuit 130 selects the next set of parameter combination and generates new control signal(s) C1 and/or C2 according to the next set of parameter combination. After the reference clock generation circuit 140 and/or the working clock generation circuit 150 complete(s) its/their respective clock adjustment(s) in response to the new control signal(s), the digital baseband circuit 130 measures the signal energy corresponding to the set of parameter combination currently selected. After obtaining the signal energy corresponding to all or selected sets of parameter combinations, the digital baseband circuit 130 can determine the set of parameter combination that is most suitable for the current operating environment based on the signal energy obtained. In one embodiment, the digital baseband circuit 130 selects the set of parameter combination corresponding to the minimum signal energy and controls the reference clock generation circuit 140 and/or the working clock generation circuit 150 to adjust its/their respective clock(s) according to the selected set of parameter combination. The receiving circuit of the wireless communication system does not receive and process the RF signal until the above procedure is completed. In this way, the influence of potentially existing interference signals can be reduced as much as possible.

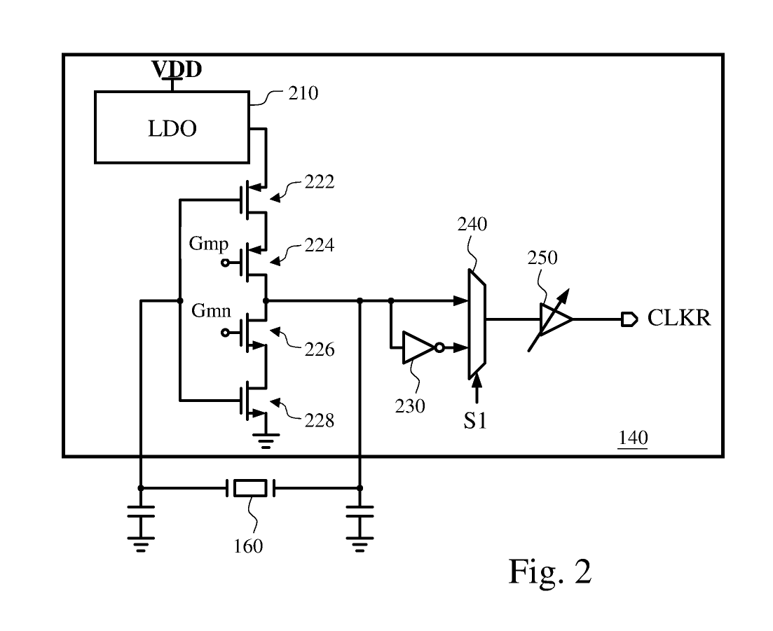

FIG. 2 is a circuit diagram of the reference clock generation circuit 140 according to an embodiment of the present invention. The reference clock generation circuit 140 includes a low dropout regulator (LDO) 210, four serially-connected transistors 222 to 228, an inverter 230, a multiplexer 240, and a buffer 250. The transistors 222 to 228 can be, for example, implemented by Metal-Oxide-Semiconductor Field-Effect Transistors (MOSFETs). The reference clock generation circuit 140 amplifies the signals using the transistors 222 and 228. The transistors 224 and 226 act as switches. As the transistors 222 to 228 are in multi-stage parallel connection, the magnitude by which the transistors 222 and 228 amplify the signals can be determined by adjusting the gate voltages Gmp and Gmn of the transistors 224 and 226 (for example, switching between 0V and the voltage source VDD). In this way, the purpose of adjusting the duty cycle of the reference clock can be achieved. The adjustment of the amplitude (or intensity) of the reference clock can be made by adjusting the voltage level of the LDO 210 and/or the number of stages of the buffer 250. The phase adjustment can be conducted by selecting the original signal or the inverted signal (the output of the inverter 230) through the phase selection signal S1.

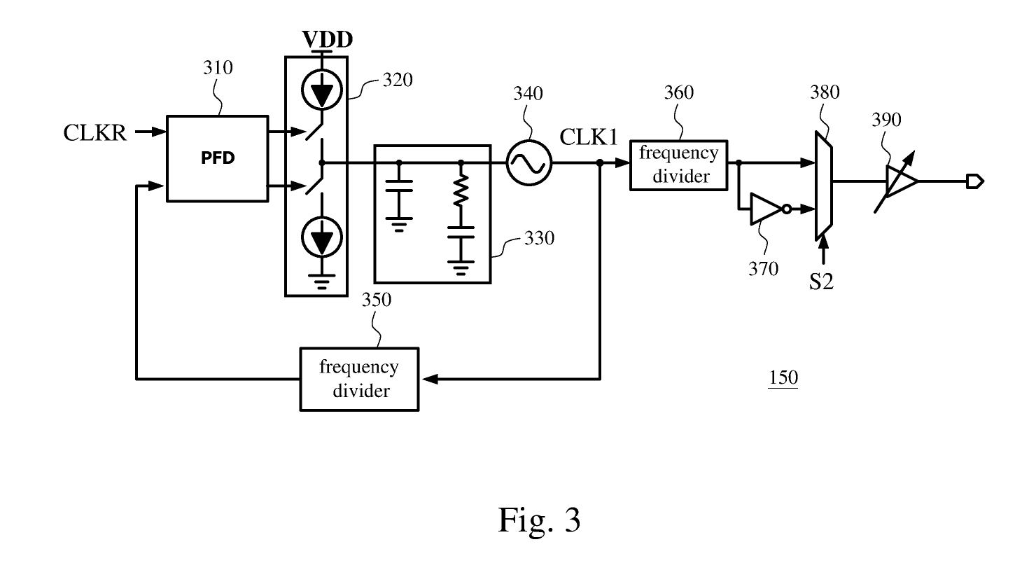

FIG. 3 is a circuit diagram of the working clock generation circuit 150 according to an embodiment of the present invention. The working clock generation circuit 150 includes a phase frequency detector (PFD) 310, a charge pump 320, a loop filter 330, a voltage-controlled oscillator (VCO) 340, frequency dividers 350, and 360, an inverter 370, a multiplexer 380, and a buffer 390. Since the elements 310 to 350 constitute a common phase-locked loop (PLL), the operation principles thereof are omitted for brevity. The frequency divider 360 is configured to divide the clock CLK1 outputted by the VCO 340 to obtain the target frequency. The adjustment of the amplitude (or intensity) of the working clock can be made by adjusting the number of stages of the buffer 390. The phase adjustment can be conducted by selecting the original signal or the inverted signal (the output of the inverter 370) through the phase selection signal S2.

Please note that FIG. 2 and FIG. 3 respectively show an embodiment of the reference clock generation circuit 140 and the working clock generation circuit 150 of the present invention. The embodiments shown in FIG. 2 and FIG. 3 are for the purpose of explanation, not for limiting the scope of this invention. A person having ordinary skill in the art may come up with a variety of circuit modifications based on the disclosure of the above embodiments, such as providing more phase options.

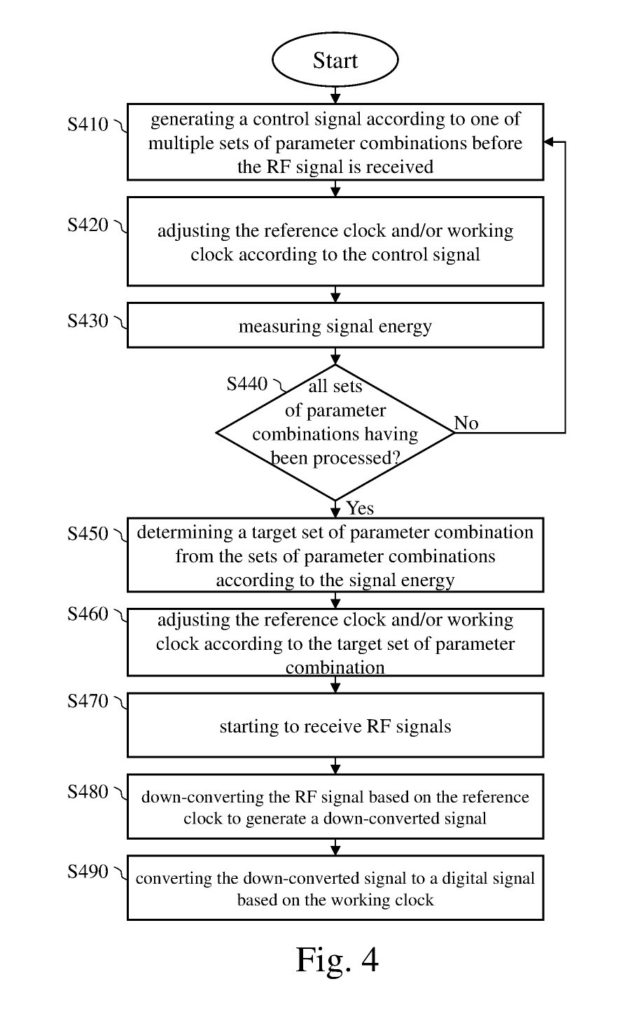

In addition to the aforementioned receiving circuit of the wireless communication system, the present invention also correspondingly discloses an RF signal receiving method that is applicable to a wireless communication system. The method is executed by the foregoing communication chip 100 or its equivalent. FIG. 4 is a flowchart of an embodiment of the method, including the following steps S410 to S490.

In step S410 one of multiple sets of parameter combinations is selected before the RF signal is received and a control signal is generated accordingly. Each set of parameter combination includes, for example, a first parameter associated with the characteristics of the reference clock such as the phase, amplitude, and/or duty cycle, and/or a second parameter associated with the characteristics of the working clock such as the phase and/or amplitude. In this step, the same control signal can be employed to adjust both the reference clock and the working clock, or different control signals may be employed to adjust the reference clock and working clock respectively. The reference clock is generated according to a base clock, and the working clock is generated according to the reference clock.

In step S420, the reference clock and/or working clock are(is) adjusted according to the control signal(s). More specifically, both the reference clock and the working clock or only one of the two can be adjusted before the RF signals are received.

In step S430, signal energy is measured. After the reference clock and/or working clock are(is) adjusted, the signal energy in the circuit is measured and the correlation between the signal energy and the set of parameter combination is recorded. This step can be performed in the digital or analog domain.

In step S440, it is determined that whether all or selected sets of parameter combinations have been processed. If negative, the flow goes back to step S410 to select another set of parameter combination and generate a control signal accordingly; if positive, the method proceeds to execute step S450.

In step S450, a target set of parameter combination is determined according to the signal energy. This step selects the set of parameter combination corresponding to the lowest signal energy according to the previous record.

In step S460, the reference clock and/or working clock are(is) adjusted according to the target set of parameter combination. As a result, the receiving circuit of the wireless communication system is operated conforming to this target set of parameter combination, thereby greatly reducing the interference intrinsic to the circuit.

In step S470, the circuit starts to receive the RF signal. The target set of parameter combination is used to operate the receiving circuit of the wireless communication system and the receiving circuit starts to receive the RF signal.

In step S480, the RF signal is down-converted based on the reference clock to generate a down-converted signal (e.g., an intermediate frequency or baseband signal). This step uses, for example, a mixer to down-convert the RF signal, and the mixer operates according to the reference clock.

In step S490, the down-converted signal is converted to a digital signal based on the working clock. This step uses, for example, an ADC to convert the down-converted signal to a digital signal, and the ADC operates according to the working clock.

The present invention can be applied, but not limited, to the receiving end of a system like a wireless network (including but not limited to Wi-Fi), Bluetooth, Global Positioning System (GPS), frequency modulation (FM), mobile communication (e.g., GSM, 3G, LTE), etc.

Since a person having ordinary skill in the art can appreciate the implementation detail and the modification thereto of the present method invention of FIG. 4 through the disclosure of the device invention of FIG. 1 to FIG. 3, repeated and redundant description is thus omitted. Please note that there is no step sequence limitation for the method inventions as long as the execution of each step is applicable. Furthermore, the shape, size, and ratio of any element and the step sequence of any flow chart in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A receiving circuit of a wireless communication system, the receiving circuit configured to receive a radio frequency (RF) signal and comprising:
a reference clock generation circuit configured to generate a reference clock according to a base clock;
a radio frequency receiving circuit configured to receive the RF signal through an antenna and down-convert the RF signal according to the reference clock to generate a down-converted signal;
a working clock generation circuit coupled to the reference clock generation circuit and configured to generate a working clock according to the reference clock;
an analog-to-digital converter coupled to the radio frequency receiving circuit and the working clock generation circuit and configured to convert the down-converted signal to a digital signal according to the working clock; and
a digital baseband circuit coupled to the working clock generation circuit, the analog-to-digital converter, and the reference clock generation circuit and configured to process the digital signal and generate at least one control signal according to a plurality of sets of parameter combinations before the radio frequency receiving circuit receives the RF signal;
wherein the at least one control signal controls the reference clock generation circuit to adjust the reference clock and/or controls the working clock generation circuit to adjust the working clock.

2. The receiving circuit of claim 1, wherein the digital baseband circuit measures signal energy of an interference signal in the digital domain, and selects one of the sets of parameter combinations according to the signal energy to determine how to control the reference clock generation circuit to adjust the reference clock and/or how to control the working clock generation circuit to adjust the working clock.

3. The receiving circuit of claim 1, wherein the reference clock generation circuit adjusts at least one of a phase, an amplitude, and a duty cycle of the reference clock.

4. The receiving circuit of claim 3, wherein the reference clock generation circuit comprises a low dropout regulator, and the reference clock generation circuit adjusts the amplitude of the reference clock by adjusting a voltage of the low dropout regulator.

5. The receiving circuit of claim 1, wherein the working clock generation circuit adjusts at least one of a phase and an amplitude of the working clock.

6. The receiving circuit of claim 1, wherein the down-converted signal is an intermediate frequency or baseband signal.

7. The receiving circuit of claim 1, wherein each set of parameter combination comprises at least a parameter associated with at least one of a phase, amplitude, and duty cycle of the reference clock.

8. A radio frequency signal receiving method applied to a receiving circuit of a wireless communication system for receiving a radio frequency (RF) signal, the method comprising:
generating a control signal according to one of a plurality of sets of parameter combinations before the RF signal is received;
adjusting a reference clock and/or a working clock according to the control signal;
measuring signal energy;
determining a target set of parameter combination from the sets of parameter combinations according to the signal energy;
adjusting the reference clock and/or the working clock according to the target set of parameter combination;
down-converting the RF signal according to the reference clock to generate a down-converted signal; and
converting the down-converted signal to a digital signal according to the working clock;
wherein the reference clock is generated according to a base clock, and the working clock is generated according to the reference clock.

9. The method of claim 8, wherein the step of adjusting the reference clock according to the control signal adjusts at least one of a phase, an amplitude, and a duty cycle of the reference clock.

10. The method of claim 8, wherein the step of adjusting the working clock according to the control signal adjusts at least one of a phase and an amplitude of the working clock.

11. The method of claim 8, wherein the down-converted signal is an intermediate frequency or baseband signal.

12. The method of claim 8, wherein each set of parameter combination comprises at least a parameter associated with at least one of a phase, amplitude, and duty cycle of the reference clock.

13. A radio frequency signal receiving method applied to a receiving circuit of a wireless communication system for receiving a radio frequency (RF) signal, the method comprising:
generating a reference clock according to a base clock;
generating a working clock according to the reference clock;
generating a control signal according to signal energy of an interference signal before the RF signal is received;
adjusting the reference clock and/or the working clock according to the control signal;
down-converting the RF signal according to the reference clock to generate a down-converted signal; and
converting the down-converted signal to a digital signal according to the working clock.

14. The method of claim 13, wherein the step of adjusting the reference clock according to the control signal adjusts at least one of a phase, an amplitude, and a duty cycle of the reference clock.

15. The method of claim 13, wherein the step of adjusting the working clock according to the control signal adjusts at least one of a phase and an amplitude of the working clock.

16. The method of claim 13, wherein the down-converted signal is an intermediate frequency or baseband signal.
